(19) United States
(12) Patent Application Publication
(10) Pub. No.: US 2017/0327077 A1
(43) Pub. Date: Nov. 16, 2017

(54) WEBBING TAKE-UP DEVICE

(71) Applicant: KABUSHIKI KAISHA TOKAI-RIKA-DENKI-SEISAKUSHO, Aichi (JP)

(72) Inventors: Kenji FUKUTA, Aichi (JP); Tetsushi MUROMACHI, Aichi (JP)

(21) Appl. No.: 15/532,408

(22) PCT Filed: Nov. 20, 2015
(86) PCT No.: PCT/JP2015/082776

§ 371 Date: Jun. 1, 2017

(30) Foreign Application Priority Data
Dec. 8, 2014 (JP) 2014-247940

(51) Int. Cl. B60R 22/36; B60R 22/34

(52) U.S. Cl. CPC B60R 22/36; B60R 22/34; B60R 2022/3427

(57) ABSTRACT

A webbing take-up device is provided with a spool and a stopper member. A webbing is taken up onto the spool. The spool includes a webbing insertion hole into which the webbing is inserted. The stopper member secures an end portion of the webbing at the spool by engaging with a periphery portion of the webbing insertion hole. The webbing take-up device is also provided with load bracing portions (a portion at an axial direction one side of a first serrated portion and a portion at an axial direction another side of a rod portion that are formed at a torsion shaft). The load bracing portions are disposed at the diametric direction inner side of the spool relative to the stopper member and are disposed to be close to the spool. The load bracing portions brace a load that is applied to the spool from the webbing via the stopper member.

### TECHNICAL FIELD

The present invention relates to a webbing take-up device.

### BACKGROUND ART

Japanese Patent Application Laid-Open (JP-A) No. 2008-1194 discloses a webbing take-up device provided with: a spool (a bobbin) that is turnably supported and onto which a webbing is taken up; and a stopper (a belt plate) to which one end of the webbing is fixed. According to the spool recited in JP-A No. 2008-1194, the end portion of the webbing is secured at the spool by a central portion of the stopper engaging with an engaging portion formed in the spool and two end portions (securing portions) of the stopper being set in setting portions formed in the spool.

However, in the structure recited in JP-A No. 2008-1194, when a load applied to the webbing is transmitted to the spool via the stopper, stress values in periphery portions of the engaging portion and setting portions formed in the spool are raised. In order to reduce these stress values, thicknesses of the periphery portions of the engaging portion and setting portions must be increased, as a result of which the spool is likely to be increased in diameter.

### SUMMARY OF INVENTION

### Technical Problem

In consideration of the circumstances described above, an object of the present invention is to provide a webbing take-up device that may suppress an increase in diameter of a spool.

### Solution to Problem

A webbing take-up device according to a first aspect of the present invention includes: a spool including a webbing insertion hole at which a webbing to be applied to a vehicle occupant is inserted, the webbing being taken up onto the spool, and the spool being turned in a pull-out direction when the webbing is pulled out; a stopper member provided at an end portion of the webbing, the stopper member securing the end portion of the webbing at the spool by engaging with a periphery portion of the webbing insertion hole; and a load bracing portion disposed at a diametric direction inner side of the spool relative to the stopper member, the load bracing portion bracing a load that is applied to the spool from the webbing via the stopper member.

In a webbing take-up device according to a second aspect of the present invention, in the webbing take-up device of the first aspect: the stopper member is formed in a long shape whose length direction is along an axial direction of the spool; and the load bracing portion is provided at each of locations of end portions at a length direction one side and another side of the stopper member, which locations oppose the spool in the diametric direction.

In a webbing take-up device according to a third aspect of the present invention, in the webbing take-up device of the second aspect: a lock portion is provided at an axial direction one side of the spool, turning of the lock portion in the pull-out direction being limited during an emergency state of a vehicle; a torsion shaft is provided at an axial central portion of the spool, a portion of the torsion shaft serving as a first coupling portion that is coupled to an end portion at an axial direction another side of the spool, another portion of the torsion shaft serving as a second coupling portion that is coupled to the lock portion, and, when the turning of the lock portion is being limited, the torsion shaft allowing turning of the spool in the pull-out direction relative to the lock portion by a load of at least a force limiter load; and a portion of at least one of the first coupling portion and the second coupling portion serves as the load bracing portion.

### Advantageous Effects of Invention

In the webbing take-up device of the first aspect of the present invention, the webbing applied to a vehicle occupant is taken up onto the spool, and the spool is turned in the pull-out direction by the webbing being pulled out from the spool.

In the present invention, because the above-mentioned load bracing portion is provided at the diametric direction inner side of the spool relative to the stopper member, a load applied to the spool from the webbing via the stopper member is braced by the load bracing portion. Therefore, deformation of a periphery portion of the webbing insertion hole due to the periphery portion of the webbing insertion hole being pressed by the stopper member can be suppressed. That is, a rise in stress values produced in the periphery portion of the webbing insertion hole can be suppressed. Thus, with the present invention, an increase in thickness of the periphery portion of the webbing insertion hole may be moderated and an increase in diameter of the spool may be suppressed.

According to the webbing take-up device of the second aspect of the present invention, deformation of the periphery portion of the webbing insertion hole that is pressed by the stopper member may be effectively suppressed by the load bracing portion being provided at each of the locations that oppose, in the diametric direction of the spool, the end portion at the length direction one side of the stopper member and the end portion at the another side.

According to the webbing take-up device of the third aspect of the present invention, an increase in a number of components structuring the webbing take-up device may be suppressed by the load bracing portions being portions of the torsion shaft. Furthermore, the structure of the torsion shaft may be simplified by a portion of at least one of the first coupling portion and the second coupling portion serving as the load bracing portion.

### BRIEF DESCRIPTION OF DRAWINGS

FIG. 1 is a front view showing a webbing take-up device.

FIG. 2 is an exploded perspective view showing a spool, a lock portion and a torsion shaft structuring portions of the webbing take-up device shown in FIG. 1.

FIG. 3 is a magnified sectional diagram showing the spool, a stopper member, a webbing and the torsion shaft, cut along line 3-3 in FIG. 1.

FIG. 4 is a magnified sectional diagram showing a section of the webbing take-up device cut along line 4-4 in FIG. 3.

### DESCRIPTION OF EMBODIMENTS

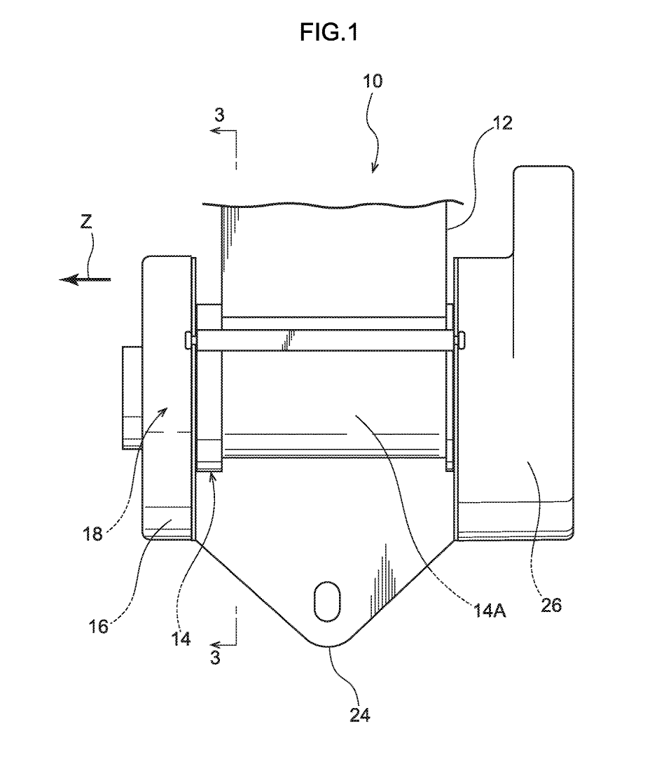

A webbing take-up device according to an exemplary embodiment of the present invention is described using FIG. 1 to FIG. 4. The directions of arrow Z, arrow R and arrow C that are shown as appropriate in the drawings indicate, respectively, an axial direction of the spool, a diametric direction of the spool and a circumferential direction of the spool. Where an axial direction, diametric direction or circumferential direction is referred to herebelow, these refer to the axial direction, diametric direction or circumferential direction of the spool unless specifically stated otherwise.

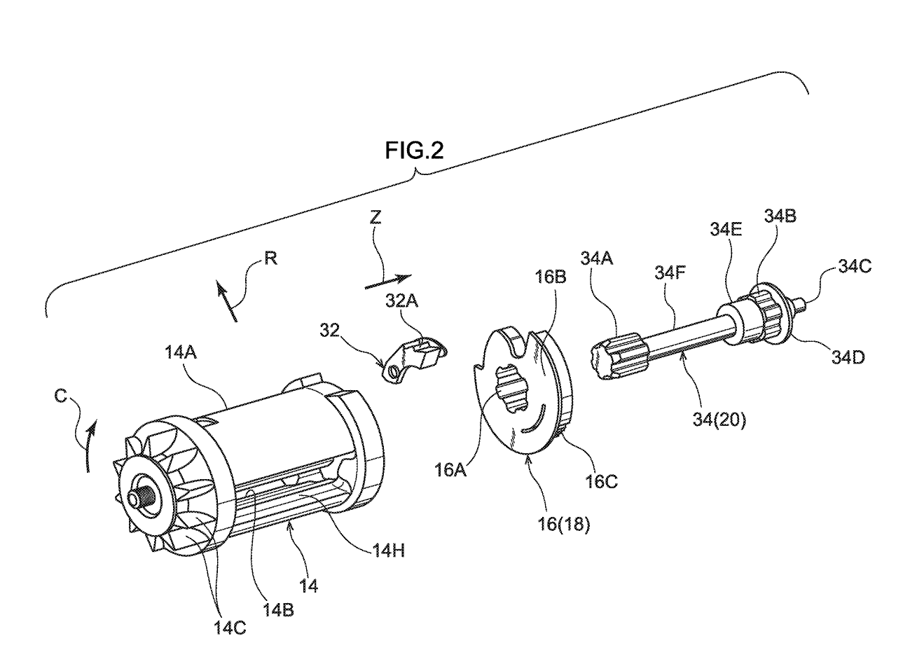

As shown in FIG. 1 and FIG. 2, a webbing take-up device 10 according to the present exemplary embodiment is provided with a spool 14 and a lock mechanism 18. A webbing 12 to be applied to a vehicle occupant is taken up onto the spool 14, and the spool 14 is turned in a pull-out direction by the webbing 12 being pulled out. The lock mechanism 18 is provided to be turnable integrally with the spool 14 and includes a lock portion 16. Turning of the lock portion 16 in the pull-out direction is limited (restricted) during an emergency state of a vehicle. The webbing take-up device 10 is further provided with a force limiter mechanism 20 that, when turning of the lock portion 16 is being restricted, allows turning of the spool 14 in the pull-out direction relative to the lock portion 16 by a load that is at least a force limiter load.

—Structure of the Spool 14—

As shown in FIG. 2, the spool 14 is provided with a take-up portion 14A that is formed in a substantially circular rod shape and onto which the webbing 12 is taken up. A webbing insertion hole 14B is formed in the take-up portion 14A. The webbing 12 is inserted into the webbing insertion hole 14B. Viewed from the diametric direction outer side, the webbing insertion hole 14B is formed in a rectangular shape whose length direction is in the axial direction. A dimension of one side opening portion of the webbing insertion hole 14B in the short direction thereof is specified to be smaller toward the axial center of the spool 14.

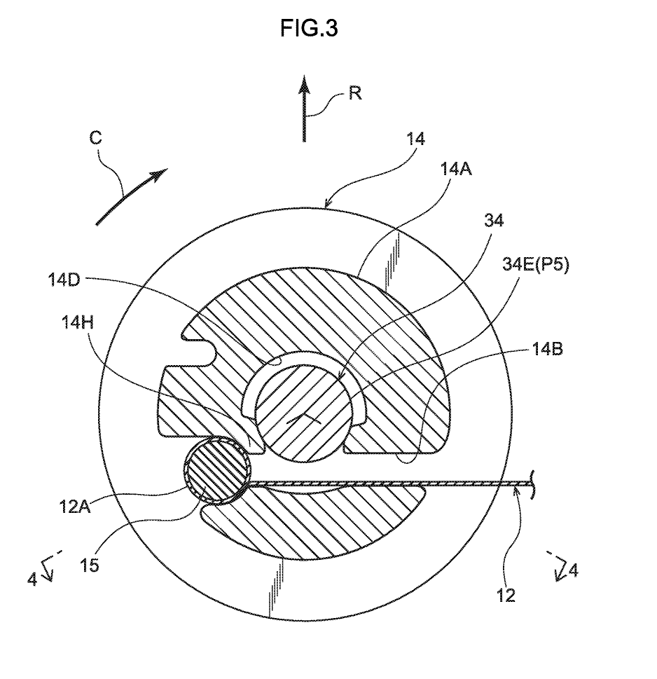

As shown in FIG. 3, a stopper member insertion portion 12A is formed at an end portion of the long direction of the webbing 12. The stopper member insertion portion 12A is formed by the end portion of the long direction of the webbing 12 being folded back and sewn to itself After the webbing 12 is inserted into the webbing insertion hole 14B, a stopper member 15 is inserted into the stopper member insertion portion 12A of the webbing 12. The end portion of the long direction of the webbing 12 is secured at the spool 14 by the webbing 12 being pulled in the pull-out direction and the stopper member 15 that is inserted into the stopper member insertion portion 12A of the webbing 12 being caught at a periphery portion 14H at the one side opening portion of the webbing insertion hole 14B.

As shown in FIG. 1, the webbing 12 extends to the upper side from a frame 24 at which the spool 14 is turnably supported, and can be applied to a vehicle occupant sitting on a seat (not shown in the drawings) of the vehicle. As shown in FIG. 2, when the spool 14 is turned to a circumferential direction another side (the direction opposite to the direction of arrow C), the webbing 12 is taken up onto the spool 14, and when the webbing 12 is pulled out from the spool 14, the spool 14 is turned to a circumferential direction one side (the direction of arrow C), which is to say the spool 14 is turned in the pull-out direction.

An engaging teeth portion 14C is provided at an end portion at an axial direction another side of the spool 14 (the direction opposite to the direction of arrow Z). The engaging teeth portion 14C constitutes a portion of a pre-tensioner mechanism 26 (see FIG. 1). When there is an emergency state of the vehicle, the pre-tensioner mechanism 26 forcibly turns the spool 14 in the take-up direction of the webbing 12.

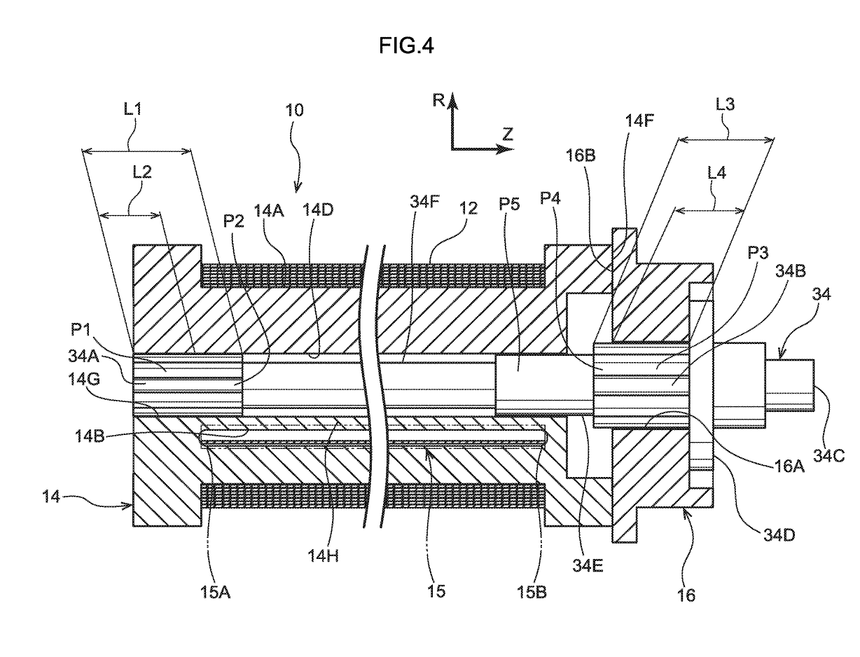

As shown in FIG. 4, a torsion shaft insertion hole 14D is formed at an axial central portion of the spool 14. A torsion shaft 34, which is described below, is inserted into the torsion shaft insertion hole 14D. An inner diameter (a minimum internal diameter) of the torsion shaft insertion hole 14D is set to be slightly larger than an outer diameter of a first serrated portion 34A, which serves as a first coupling portion. The first serrated portion 34A is formed at an end portion at the axial direction another side of the torsion shaft 34. A first serrated portion engaging portion 14G is formed at an end portion at the axial direction another side of the torsion shaft insertion hole 14D. The first serrated portion 34A of the torsion shaft 34 engages with the first serrated portion engaging portion 14G. Seen from the axial direction one side, an inner edge portion of the first serrated portion engaging portion 14G is formed in a shape that corresponds with the shape of an outer edge portion of the first serrated portion 34A. The end portion at the axial direction another side of the torsion shaft 34 and the spool 14 are coupled to be integrally turnable by the first serrated portion 34A of the torsion shaft 34 engaging with the first serrated portion engaging portion 14G. The coupling of the first serrated portion 34A of the torsion shaft 34 with the first serrated portion engaging portion 14G is prevented from disengaging by a first support member, which is not shown in the drawings, that is attached to the spool 14.

—Structure of the Lock Mechanism 18—

As shown in FIG. 1 and FIG. 2, the lock mechanism 18 includes the lock portion 16, which is provided at the axial direction one side of the spool 14, and a lock piece 32, which is attached to the lock portion 16.

As shown in FIG. 2, the lock portion 16 is formed in a substantially circular plate shape whose thickness direction is along the axial direction. A first engagement receiving tooth 16C is formed at the lock portion 16. The first engagement receiving tooth 16C engages with ratchet teeth, which are not shown in the drawing, that are provided at the frame 24 (see FIG. 1) during an emergency state of the vehicle (during a collision of the vehicle, when the spool 14 is suddenly pulled out from the webbing 12, there is a sudden deceleration of the vehicle or the like). A second engagement receiving tooth 32A is formed at the lock piece 32. The second engagement receiving tooth 32A also engages with the ratchet teeth. A second serrated portion engaging portion 16A is formed at an axial central portion of the lock portion 16. A second serrated portion 34B, which serves as a second coupling portion, engages with the second serrated portion engaging portion 16A. The second serrated portion 34B is formed at an end portion at the axial direction one side of the below-described torsion shaft 34. The second serrated portion engaging portion 16A penetrates through the axial central portion of the lock portion 16 in the axial direction. Seen from the axial direction one side, an inner edge portion of the second serrated portion engaging portion 16A is formed in a shape that corresponds with the shape of an outer edge portion of the second serrated portion 34B. The end portion at the axial direction one side of the torsion shaft 34 and the lock portion 16 are coupled to be integrally turnable by the second serrated portion 34B of the torsion shaft 34 engaging with the second serrated portion engaging portion 16A. As shown in FIG. 4, in a state in which the webbing take-up device 10 has been assembled, an end face 16B at the axial direction another side of the lock portion 16 abuts against an end 14F at the axial direction one side of the spool 14.

—Structure of the Force Limiter Mechanism 20—

As shown in FIG. 4, the force limiter mechanism 20 includes the torsion shaft 34, which is formed in a substantially circular rod shape. The first serrated portion 34A that engages with the first serrated portion engaging portion 14G provided at the spool 14 is formed at the end portion at the axial direction another side of the torsion shaft 34. A dimension L1 of the first serrated portion 34A in the axial direction is set to be longer than a dimension L2 of the first serrated portion engaging portion 14G in the axial direction. Consequently, a portion P1 at the axial direction another side of the first serrated portion 34A engages with the first serrated portion engaging portion 14G and a portion P2 at the axial direction one side of the first serrated portion 34A does not engage with the first serrated portion engaging portion 14G.

The second serrated portion 34B that engages with the second serrated portion engaging portion 16A provided at the lock portion 16 is formed at the end portion at the axial direction one side of the torsion shaft 34. An outer diameter of the second serrated portion 34B is set to be larger than an outer diameter of the first serrated portion 34A. A dimension L3 of the second serrated portion 34B in the axial direction is set to be longer than a dimension L4 of the second serrated portion engaging portion 16A in the axial direction. Consequently, a portion P3 at the axial direction one side of the second serrated portion 34B engages with the second serrated portion engaging portion 16A and a portion P4 at the axial direction another side of the second serrated portion 34B does not engage with the second serrated portion engaging portion 16A.

A portion of the torsion shaft 34 at the axial direction another side relative to the second serrated portion 34B is a rod portion 34E that is formed in a substantially circular rod shape. An outer diameter of the rod portion 34E is set to be slightly larger than the inner diameter (minimum internal diameter) of the torsion shaft insertion hole 14D and to be substantially the same as the outer diameter of the first serrated portion 34A. The outer diameter of the rod portion 34E substantially matches a diameter of valleys of the second serrated portion 34B.

A portion of the torsion shaft 34 between the rod portion 34E and the first serrated portion 34A serves as a twisting portion 34F, which is specified with an outer diameter smaller than the outer diameter of the rod portion 34E.

In the state in which the webbing take-up device 10 has been assembled, the portion P2 at the axial direction one side of the first serrated portion 34A, which serves as a load bracing portion, is disposed to oppose an end portion 15A at a long direction another side of the stopper member 15 in the diametric direction. A portion P5 at the axial direction another side of the rod portion 34E, which also serves as a load bracing portion, is disposed to oppose an end portion 15B at the long direction one side of the stopper member 15 in the diametric direction. Outer periphery faces of the portion P2 at the axial direction one side of the first serrated portion 34A and the portion P5 at the axial direction another side of the rod portion 34E are disposed to be close to inner periphery faces of minimum internal diameter portions of the torsion shaft insertion hole 14D.

A supported portion 34C is provided at the axial direction one side of the torsion shaft 34 relative to the second serrated portion 34B. The supported portion 34C is supported by a second support member, which is not shown in the drawings. A flange portion 34D is provided at a boundary between the supported portion 34C and the second serrated portion 34B. The flange portion 34D has a larger diameter than the second serrated portion 34B. Movement of the torsion shaft 34 to the axial direction another side relative to the lock portion 16 is restricted by the flange portion 34D abutting against the lock portion 16.

—Operation and Effects of the Present Exemplary Embodiment—p Now, operation and effects of the present exemplary embodiment are described.

As shown in FIG. 1, in the webbing take-up device 10 according to the present exemplary embodiment, the webbing 12 is pulled out from the spool 14 and applied to a vehicle occupant sitting on a seat of a vehicle, which is not shown in the drawings.

As shown in FIG. 1 to FIG. 3, during an emergency state of the vehicle (during a collision of the vehicle or the like), the lock mechanism 18 is activated and thus turning of the lock portion 16 in the pull-out direction is restricted. Consequently, turning of the spool 14 in the pull-out direction relative to the lock portion 16 is limited via the torsion shaft 34, pulling out of the webbing 12 from the spool 14 is limited, and the vehicle occupant is restrained by the webbing 12.

In the state in which turning of the spool 14 in the pull-out direction relative to the lock portion 16 is limited by the torsion shaft 34, if a load acting on the vehicle occupant from the webbing 12 (and a load acting on the webbing 12 from the vehicle occupant) becomes at least a predetermined value (a force limiter load), the twisting portion 34F of the torsion shaft 34 twists and deforms. Thus, turning of the spool 14 in the pull-out direction relative to the lock portion 16 by a load of at least the force limiter load is allowed. Consequently, kinetic energy of the vehicle occupant is absorbed by the deformation of the twisting portion 34F of the torsion shaft 34, and the load acting on the vehicle occupant from the webbing 12 is reduced.

In the present exemplary embodiment, the outer periphery faces of the portion P2 at the axial direction one side of the first serrated portion 34A and the portion P5 at the axial direction another side of the rod portion 34E that are formed at the torsion shaft 34 are close to the inner periphery faces of the torsion shaft insertion hole 14D formed in the axial central portion of the spool 14. Therefore, in the state in which the webbing 12 that was taken up onto the spool 14 has been completely pulled out from the spool 14, if the webbing 12 is pulled further in the pull-out direction, the stopper member 15 installed at the end portion of the webbing 12 presses against the periphery portion 14H of the webbing insertion hole 14B formed in the spool 14. When this happens, the periphery portion 14H of the webbing insertion hole 14B deforms slightly toward the diametric direction inner side. As a result, the inner periphery face of the torsion shaft insertion hole 14D abuts against the portion P2 at the axial direction one side of the first serrated portion 34A and the outer periphery face of the portion P5 at the axial direction another side of the rod portion 34E that are formed at the torsion shaft 34. Therefore, deformation of the periphery portion 14H of the webbing insertion hole 14B due to the periphery portion 14H of the webbing insertion hole 14B being pressed against by the stopper member 15 is suppressed. That is, a rise in stress values produced in the periphery portion 14H of the webbing insertion hole 14B is suppressed. Thus, with the present exemplary embodiment, an increase in thickness of the periphery portion 14H of the webbing insertion hole 14B may be moderated and an increase in diameter of the spool 14 may be suppressed.

In the present exemplary embodiment, the portion P2 at the axial direction one side of the first serrated portion 34A and the portion P5 at the axial direction another side of the rod portion 34E that are formed at the torsion shaft 34 are provided at positions opposing in the diametric direction, respectively, the end portion 15A at the length direction another side and the end portion 15B at the length direction one side of the stopper member 15. Therefore, deformation of the periphery portion 14H of the webbing insertion hole 14B being pressed by the stopper member 15 may be suppressed effectively.

The present exemplary embodiment is a structure in which a load applied from the stopper member 15 to the periphery portion 14H of the webbing insertion hole 14B formed in the spool 14 is braced by a portion of the torsion shaft 34. Therefore, compared to a structure in which an alternative member is additionally provided in order to brace this load, an increase in the number of components structuring the webbing take-up device 10 may be suppressed.

In the present exemplary embodiment, an example is described of a structure in which the load applied from the stopper member 15 to the periphery portion 14H of the webbing insertion hole 14B formed in the spool 14 is braced by a portion of the torsion shaft 34, but the present invention is not limited thus. For example, in a webbing take-up device in which the torsion shaft 34 is not provided, it is sufficient that a load bracing portion that braces this load is provided at an axial central portion of the spool 14.

In the present exemplary embodiment, an example is described in which the portion P2 at the axial direction one side of the first serrated portion 34A and the portion P5 at the axial direction another side of the rod portion 34E that brace the load described above are disposed at positions that oppose in the diametric direction, respectively, the end portion 15A at the length direction another side and the end portion 15B at the length direction one side of the stopper member 15, but the present invention is not limited thus. For example, a load bracing portion that braces this load may be disposed at a position that opposes a length direction middle portion of the stopper member 15 in the diametric direction. Thus, it is sufficient if the arrangement of load bracing portions is specified appropriately in consideration of the shape of the stopper member 15, stress distribution in the periphery portion 14H of the webbing insertion hole 14B, and the like.

Hereabove, an exemplary embodiment of the present invention has been described. The present invention is not limited by these descriptions and it will be clear that numerous modifications outside of these descriptions may be embodied within a technical scope not departing from the gist of the invention.

The disclosures of Japanese Patent Application No. 2014-247940 filed Dec. 8, 2014 are incorporated into the present specification by reference in their entirety.

1. A webbing take-up device comprising:
a spool including a webbing insertion hole at which a webbing to be applied to a vehicle occupant is inserted, the webbing being taken up onto the spool, and the spool being turned in a pull-out direction when the webbing is pulled out;
a stopper member provided at an end portion of the webbing, the stopper member securing the end portion of the webbing at the spool by engaging with a periphery portion of the webbing insertion hole; and
a load bracing portion disposed at a diametric direction inner side of the spool relative to the stopper member, the load bracing portion bracing a load that is applied to the spool from the webbing via the stopper member.

2. The webbing take-up device according to claim 1, wherein:
the stopper member is formed in a long shape whose length direction is along an axial direction of the spool; and
the load bracing portion is provided at each end portions at a length direction one side and another side of the stopper member, where locations at the load bracing portion oppose the spool in the diametric direction.

3. The webbing take-up device according to claim 2, wherein:
a lock portion is provided at an axial direction one side of the spool, turning of the lock portion in the pull-out direction being limited during an emergency state of a vehicle;
a torsion shaft is provided at an axial central portion of the spool, a portion of the torsion shaft serving as a first coupling portion that is coupled to an end portion at an axial direction other side of the spool, another portion of the torsion shaft serving as a second coupling portion that is coupled to the lock portion, and, when the turning of the lock portion is limited, the torsion shaft allowing turning of the spool in the pull-out direction relative to the lock portion by a load of at least a force limiter load; and
a portion of at least one of the first coupling portion and the second coupling portion serves as the load bracing portion.
